(19) United States
(12) Patent Application Publication
(10) Pub. No.: US 2005/0158427 A1
(43) Pub. Date: Jul. 21, 2005

(54) Means and device for decorating food items

(75) Inventors: William R. Palmer, Rescue, CA (US); Stephen L. Palmer, Cameron Park, CA (US)

Correspondence Address: MCHALE & SLAVIN, P.A., 2855 PGA BLVD, PALM BEACH GARDENS, FL, 33410, US

(73) Assignee: Sierra Innotek, Inc., Cameron Park, CA (US)

(21) Appl. No.: 11/038,950

(22) Filed: Jan. 18, 2005

Related U.S. Application Data
(60) Provisional application No. 60/537,322, filed on Jan. 15, 2004.

(51) Int. Cl. A23G 1/00

(52) U.S. Cl. 426/89

(57) ABSTRACT

The present invention is directed toward a simple, hand-held, disposable device and a kit used to decorate and enhance the presentation of food. The device creates decorative shavings of food items of a desired thickness and curl. Particularly, the device creates decorative shavings of food items of a uniform, aesthetically pleasing design in a safe, effective and economical manner while being able to retain and store any unshaved portion of the food item therein.

### CROSS REFERENCE TO RELATED APPLICATION

This application is based upon Provisional Patent Application 60/537,322, filed on Jan. 15, 2004, the contents of which are herein incorporated by reference.

### FIELD OF THE INVENTION

The present invention is directed towards a simple, hand-held, disposable device used to decorate and enhance the presentation of food; particularly towards a device which creates decorative shavings of food items of a desired thickness and curl; most particularly to a device that creates decorative shavings of food items of a uniform, aesthetically pleasing design while being able to retain and store any unshaved portion of the food item therein.

### BACKGROUND OF THE INVENTION

There is often a desire to enhance the appearance of food items for human consumption, especially on notable occasions (holidays, birthdays, weddings, etc). Careful control of color, surface texture and physical arrangement of edible objects can enhance the appeal of the food item. Often, various toppings are added to food items so that they are more appealing to the eye.

For example, chocolate is one of the most popular food items used to embellish and enhance the flavor of desserts (cake, truffles, ice cream, etc). Sometimes the chocolate is applied in the form of thin flakes, ribbons or shavings. Currently, if one wishes to decorate a food using chocolate shavings, two options exist. First, one may purchase and use pre-shaved chocolate. Typically such chocolate is bulk packaged in plastic bags. However, a number of significant problems typically arise when using pre-shaved chocolate to decorate food items. The delicate nature of the chocolate shavings means that the shavings do not readily survive packaging and transport. Frequently, a significant portion of the packaged shaved chocolate is broken into small pieces and fines before it can be utilized by the end-user. Secondly, the relatively large surface area of the chocolate shaving to its mass invites degradation from the atmosphere by oxidation and humidity. Additionally, thin chocolate shavings are very sensitive to melting and/or “blooming” since these shavings have relatively low thermal mass and are readily warmed upon exposure to elevated temperatures.

Another option available to one wishing to decorate with chocolate (or similar food products) requires the use of a sharp knife, peeler, or grater to create the desired shavings. It may also be necessary to warm the chocolate so that the knife or peeler will perform satisfactorily. Considerable skill is required to produce the thin, delicate shavings or curls which are most often desired. Frequently, the knife or peeler will dig into the chocolate too deeply. This discontinuous action of the blade against the food product results in irregular shards or partial curls and production of “fines,” which are generally less desirable than uniform curls.

Further, chocolate has a relatively high yield strength and considerable force is often required to force the knife or peeler blade through the chocolate. Moreover, it is difficult to hold the piece of chocolate to be shaved as heat from one's fingers causes the chocolate to melt and become slippery. Further difficulty is encountered if the chocolate bar to be shaved is small, making an adequate grip difficult. This can create a dangerous situation as the blade of the knife, peeler or grater comes ever closer to the user's hand holding the chocolate. Many cooks have at one time or another accidentally sliced their knuckles using a grater to grate foods.

Additional problems often arise when attempting to grate or shave chocolate from a hand held chocolate bar as the sufficient amount of shavings have been generated but some of the chocolate bar remains. Unless the remaining unshaved portion is wasted, a means of packaging and storing must be devised for this unused portion so that it can be saved for future use. Lastly, any of the tools used to generate the shavings must be cleaned and stored for future use.

There are numerous commercially available food-processing devices and storage container systems for grating, slicing and crushing food items. However, many of the designs found in the prior art make no attempt to precisely control the feed rate of the food to be processed with respect to the cutting motion of the blade(s). Most of these designs rely on manually applied force by the user to urge the food product into contact with the moving blade. Such means cannot be relied upon to produce uniform, aesthetically pleasing shavings or curls. Indeed, most prior art devices are not able to produce shavings or curls but rather only generate irregular granules, flakes or powder.

For example U.S. Pat. No. 6,409,107 to Romano discloses a hand-held food processor for grating garlic or the like in which a reciprocating flat blade is forced across the face of a food product. The feed rate of the food into the cutter blade is dependent upon the force manually applied by the user.

U.S. Pat. No. 5,226,353 to Hanson describes a machine for forming chocolate spiral shavings. This machine is powered by electric motors and utilizes a reciprocating blade action to produce chocolate shavings. The machine is of an industrial type and is not intended to be hand-held.

U.S. Pat. No. 5,071,663 to Dugan discloses a cheese grater and package in which the grater device also provides a storage receptacle for the cheese contained therein. Again, the rate of feed of the cheese product into the grater blade is dependent on the application of manual force by the user. Since the product is intended to produce gratings of indeterminate shape and not delicate curls, this means of feeding the cheese into the grating blade is sufficient.

U.S. Pat. No. 936,101 to Edwards teaches a reusable soap granulator intended to grate bars of soap. This device employs a feeder screw mechanism to force a bar of soap into a grating blade assembly. Unlike the present invention, this prior art device uses a toothed blade to granulate the soap, and is incapable of producing decorative shavings. Additionally, this device is to be reused by opening and disassembling the device by the user so that it may be reloaded with soap, thereby exposing the user to the toothed arm and possible injury.

U.S. Pat. No. 4,127,375 to Nelson describes a re-loadable dispensing device for producing a plurality of uniform dough masses. The device employs a hand operated crank to extrude and cut the dough into masses. A feed screw forces the dough through an extrusion plate whereupon it is cut into pieces by a rotating flat blade.

U.S. Pat. No. 3,552,460 to Cooney describes an apparatus for cutting blocks of chocolate and the like. The device comprises a tubular housing having fixed blades, a rotatable, non-cylindrical barrel and a follower for urging a block of material into contact with the blades. No means of controlling the feed rate is provided other than manual application of force by the user.

U.S. Pat. No. 1,025,513 to Craven describes a receptacle for containing and discharging solid and semisolid substances. The device of this invention employs a feed screw to advance the material to be grated into a blade, which rotates relative to the material to be grated. Disclosed is the fact that the device can be used to reduce chocolate to a fine condition, not distinct shavings.

U.S. Pat. No. 4,082,230 to Steinko describes a cheese grater and container. In this device a reversible blade/cover assembly is employed to either cover the food product in the container or, alternately, to grate the product. The force applied by the user determines product feed into the grater blade.

While the foregoing described prior art devices have advanced the art in a variety of ways, there nevertheless remains a need for an improved food processing device to produce delicate shavings, curls and other interesting shapes from food items, particularly chocolate or the like, which is economical to manufacture, simple to assemble, and permits the consistent production of uniformly reproducible decorative food products by individuals of average skill, in a safe, effective and economical manner.

### SUMMARY OF THE INVENTION

While the use of food items, such as chocolate shavings to embellish the appearance and flavor of foods such as cakes and the like was known, prior to the instantly disclosed invention there was no adequate means in the art by which one could effectively utilize commercially prepared shavings, nor a process of producing one's own shavings using conventional means.

Accordingly, it is the principle objective of this invention to provide a convenient, simple and safe means to produce decorative, reproducible and precise shavings of a food item on demand, while simultaneously providing a sanitary and convenient storage receptacle for any unshaven portion thereof. Because the shavings are produced at the time of use, the aforementioned problems of oxidation, moisture degradation, melting, and production of undesirable fines are substantially reduced.

It is a further object of this invention to disclose a device wherein the food item to be shaved is securely held in place relative to the motion of the cutting blade and, since the feed rate of the food product relative to the rotation of the blade is precisely controlled, precision shavings result, requiring little skill by the operator.

Still another objective of this invention is to disclose a device wherein the user's fingers are not in contact with the food to be shaved, such that body heat is not transferred to the food causing it to melt.

Another objective of the present invention is to disclose a device wherein the cutting blades are safely contained therein such that there is little possibility of injury to the end user.

Yet still another objective of this invention is to provide for increased sanitation since the user's fingers never come in contact with the food product.

An additional object of the instant invention is to teach a means wherein the bulk of the food item is substantially sealed from the atmosphere, thereby substantially reducing degradation.

Another objective of the instant invention is to provide a device that is economical to manufacture in that it has few components or complicated moving parts.

Yet an additional objective of the instant invention is to provide a device that is easily assembled, and which, once assembled, is reliable and resistant to disassembly.

Other objectives and advantages of this invention will become apparent from the accompanying descriptions taken in conjunction with the accompanying drawings wherein are set forth, by way of illustration and example, certain embodiments of this invention. The drawings constitute a part of this specification and include exemplary embodiments of the present invention and illustrate various objects and features thereof. It will be readily appreciated by those skilled in the art that the use of a simple, hand-held, disposable apparatus for creating decorative slices of food items is highly effective and useful in the culinary art.

### BRIEF DESCRIPTION OF THE FIGURES

FIG. 1A illustrates an isometric view of a first embodiment of the shaver assembly with integral shaving means;

FIG. 1B is a cross-sectional view of the embodiment of FIG. 1A as seen along axis 1-1 in FIG. 1A;

FIG. 2A is an exploded view of the embodiment of FIG. 1A;

FIG. 2B is a cross-sectional view of the first embodiment of the end-piece portion of the shaver assembly;

FIG. 2C is a cross-sectional view of the end-piece portion of the shaver assembly as seen along axis 2-2 in FIG. 2B;

FIG. 3 illustrates the first embodiment of the shaver assembly in operation;

FIG. 4 illustrates a second embodiment of the shaver assembly with integral shaving means;

FIG. 5A is an exploded view of the embodiment of FIG. 4;

FIG. 5B is a cross-sectional view of an alternative embodiment of the end-piece portion of the shaver assembly;

FIG. 5C is a cross-sectional view of the alternative embodiment of the end-piece portion of FIG. 5B as seen along axis 3-3;

FIG. 6 illustrates the second embodiment of the shaver assembly in operation;

FIG. 7A illustrates the angle of attack normal to the tangent formed along the longitudinal axis of the food item, as seen along the plane transverse to the food item;

FIG. 7B illustrates the angle of attack which is less than normal to the tangent formed along the longitudinal axis of the food item and the relief angle, as seen along the plane transverse to the food item;

FIG. 7C illustrates the angle of the blade relative to the transverse axis of the food item.

### DEFINITIONS

The following list defines terms, phrases and abbreviations used throughout the instant specification. Although the terms, phrases and abbreviations are listed in the singular tense the definitions are intended to encompass all grammatical forms.

As used herein, the term “food item” refers to any edible item, which may be desirous to obtain in the form of a decorative shaving. Non-limiting examples of suitable food item include chocolate, nougat, caramel, butter, toffee, meat, cheese, dough, nuts, fruit, vegetable, marzipan, pet food and combinations thereof.

As used herein, the term “shaving” is used to denote the formation of a single continuous segment of the food item obtained from a single stroke of the cutting means across the food item. Different configurations of shavings include, albeit not limited to, helical, spiral or telescopic type curls, and relatively flat, uncurled ribbons.

### DETAILED DESCRIPTION OF PREFERRED EMBODIMENTS

Detailed embodiments of the instant invention are disclosed herein, however, it is to be understood that the disclosed embodiments are merely exemplary of the invention, which may be embodied in various forms. Therefore, specific functional and structural details disclosed herein are not to be interpreted as limiting, but merely as a basis for the claims and as a representative basis for teaching one skilled in the art to variously employ the present invention in virtually any appropriately detailed structure.

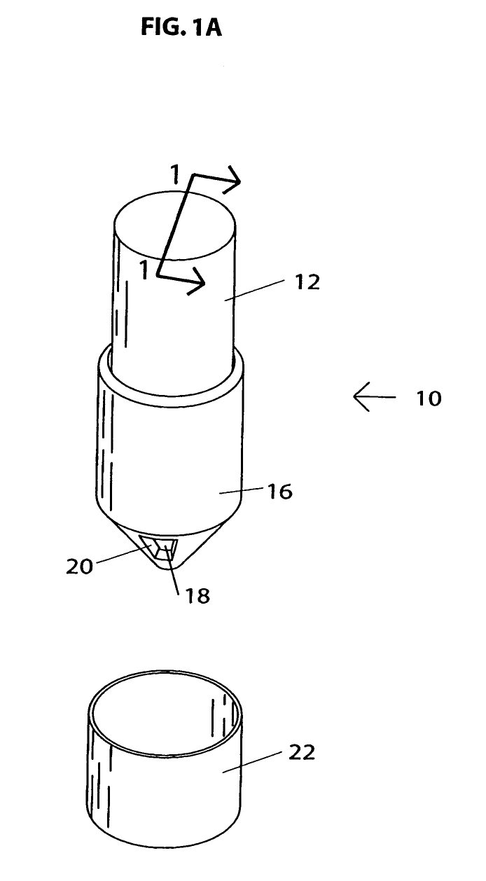

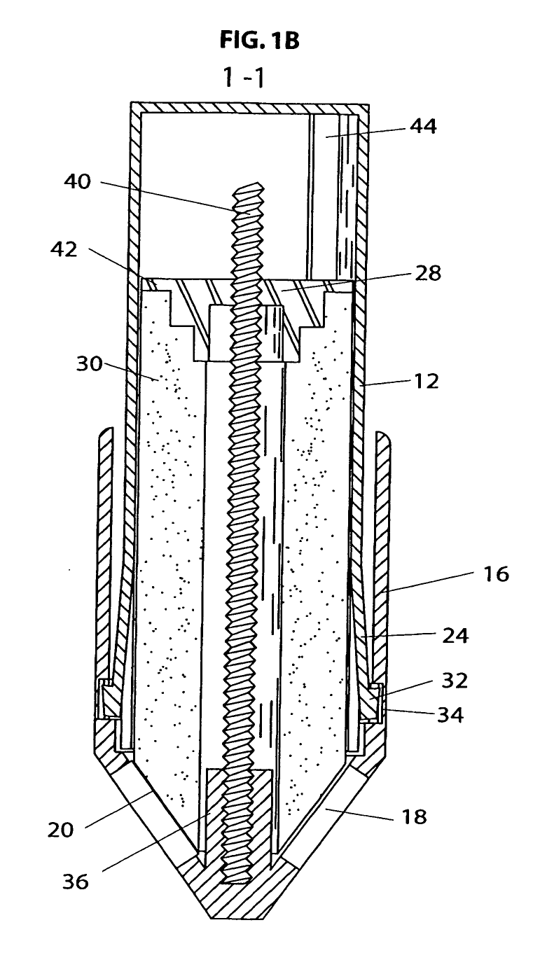

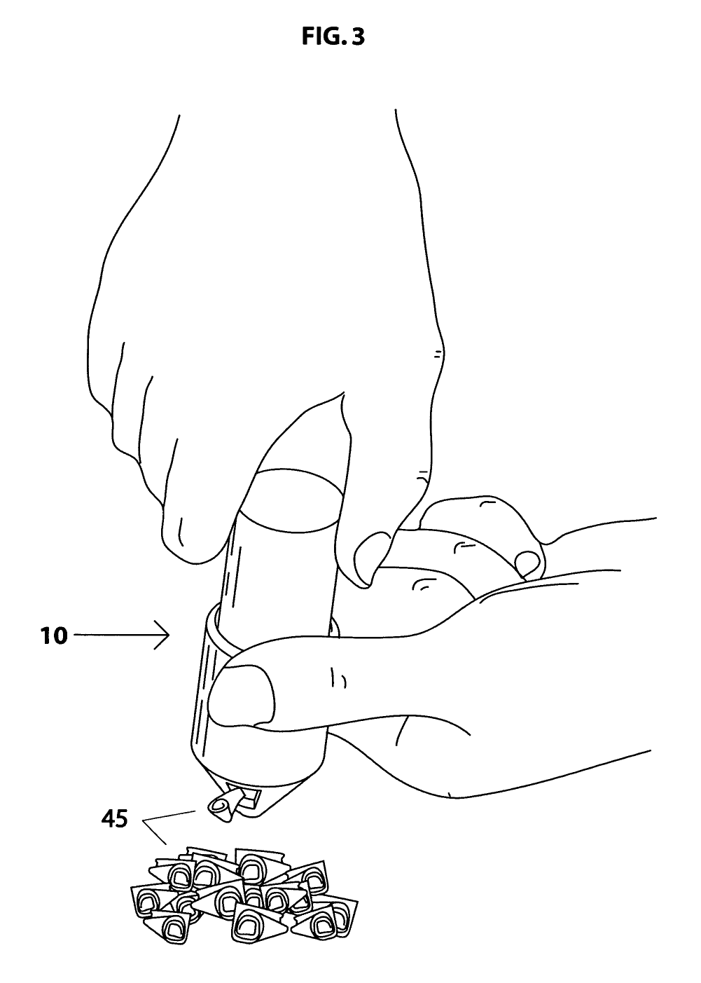

Referring now to FIGS. 1A-3, wherein like elements are numbered consistently throughout, FIG. 1A shows an isometric view of the assembled shaver assembly, or device, generally referenced as 10 according to a preferred embodiment of the present invention. In this embodiment, the shaver assembly 10 comprises container 12 and an end-piece 16. The end-piece 16 has at least one chamfered cutting means 20, such as a blade, and at least one opening, or window, 18 positioned adjacent to the cutting means 20 through which shavings 45 fall out (FIG. 3.)

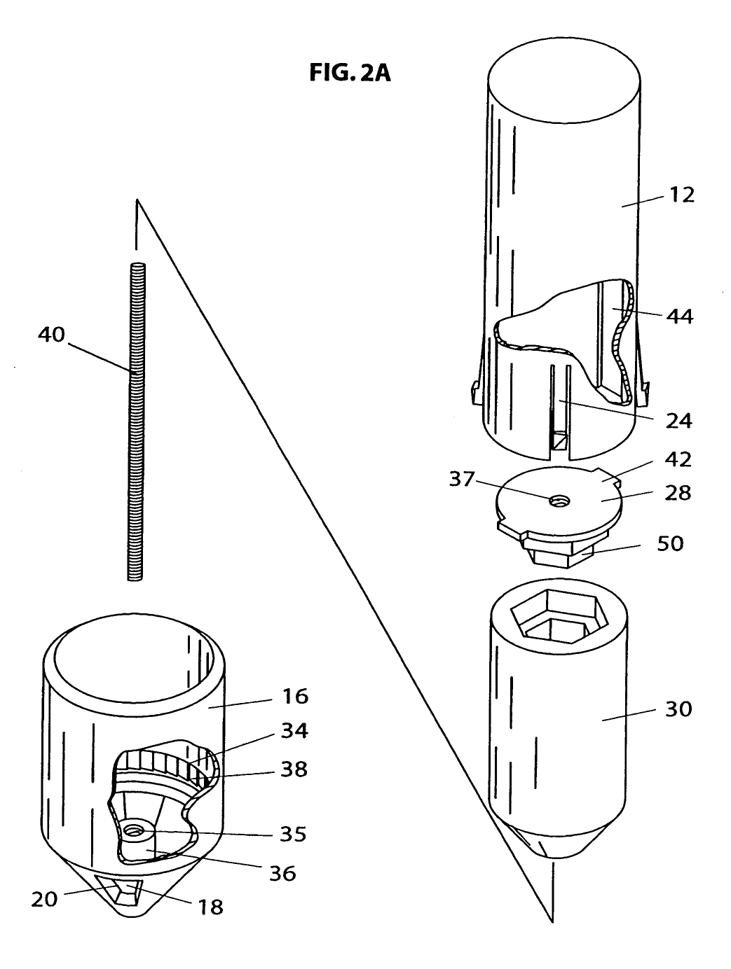

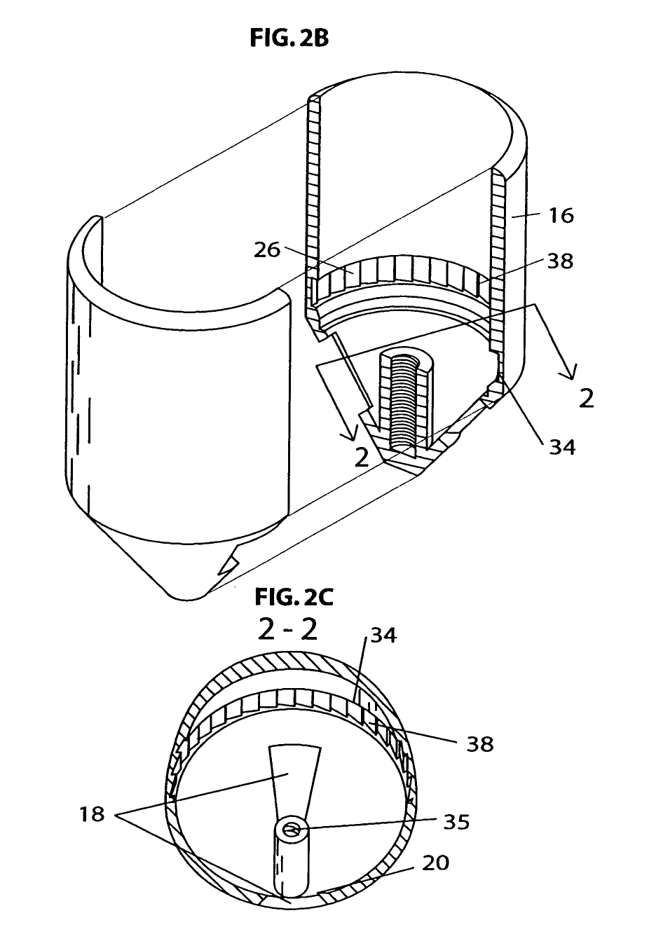

The container 12 is comprised of a generally cylindrical tube with an enclosed first end. The second end of the container 12 and end-piece 16 are operatively engaged in a manner effective to provide unidirectional rotation of the end-piece relative to the longitudinal axis of the container. For example, as seen in the preferred, albeit non-limiting embodiment shown in FIGS. 1B and 2A, the opposite end of the container 12 includes a plurality of spaced apart ratchet fingers 24 formed from a flexible material and that can be forced inward with respect to the sidewall of container 12 when the container 12 is inserted into mating relationship with the end-piece 16 during assembly of the device.

FIG. 2B depicts the cross-sectional view of the end-piece 16 in which the details of ratchet ring 26 may be clearly seen. The ratchet ring 26 comprising an integrally formed retainer groove 34 with a plurality of ramped teeth 38 formed therein. Each of the spaced apart ratchet fingers 24 includes locking projections, or lugs, 32 formed on the ends thereof. When the end-piece 16 is place over the end of the container 12, the ratchet fingers 24 “snap-fit” or engage the retainer groove 34 to prevent the end-piece 16 from being pulled off the container 12 once the device has been assembled. Additionally, these ratchet fingers 24 operatively engage the ramped teeth 38 of the end-piece 16 to provide unidirectional rotation of the end-piece 16 relative to container 12. Alternatively, although not illustrated, it is contemplated by the instant invention that second end of said container 12 could include a ratchet ring 26 with an integrally formed retainer groove 34 and plurality of ramped teeth 38 formed therein for receipt of at least one spaced apart ratchet fingers 24 integrally formed on the end-piece 16. Like the aforementioned configuration, the ratchet fingers 24 can include locking projections 32 formed on the ends thereof such that when the container 12 is placed over the end-piece 16 the ratchet fingers 24 engage the retainer groove 34 to prevent the container 12 from being counter-rotated and separated from the end-piece 16 once the device 10 has been assembled.

FIG. 2C illustrates how the cutting means 20 extends into the interior region of end-piece 16 at a predetermined angle relative to the 2-2 axis shown in FIG. 2B.

As illustrated in FIGS. 1B and 2A, the interior of the assembly 10 includes a follower 28 with a threaded through-hole 37 that operatively mates with a threaded rod 40 so that as the rod 40 is rotated relative to the follower 28, the follower 28 translates along the longitudinal length of the rod 40. The threads in the through-hole 37 may be of a ratcheting type such that the follower 28 may be pushed along the length of threaded rod 40 until it is nested into a mating relationship with a preformed food item 30 pre-packaged therein. Ratcheting threads of this type are sometimes referred to as “jam nuts” and would aid in quick assembly of the device.

As illustrated in FIGS. 1B and 2A, the peripheral edge of the follower 28 is generally of the same transverse shape as the container 12. Additionally, the follower 28 is prevented from rotating relative to container 12 by a means to engage corresponding elements formed within the container sidewalls 12. In one preferred embodiment, the means to engage includes at least one wing 42 formed on the peripheral edge of the follower that slidingly fit within at least one correspondingly sized groove 44 formed on the interior surface of the container 12. Conversely, the means to engage could contain at least one wing (not shown) projecting from the interior surface of the container that slidingly engages at least one corresponding groove formed on the peripheral edge of the follower 28.

As shown in FIGS. 2A and 1B, the threaded rod 40 is non-rotatably attached to a corresponding threaded annular support 36 by a female blind thread 35, however, any suitable fastening means known in the art can used (e.g. pins, clamps, latches, set screws, etc). Thus, as the user rotates the end-piece 16, the follower 28 moves longitudinally downward relative to the container 12 and the food item 30 is urged towards the cutting means 20 in a predetermined and precise amount.

The space between food item 30 and the interior walls of container 12 is kept to a minimum leaving just enough annular space for the food item 30 to be advanced along the longitudinal length of container 12. This ensures that the food item 30 is securely held in place and its alignment relative to the central longitudinal axis is maintained with respect to the rotation of the cutting means. The intimate rotational and longitudinal interaction of container 12 with end-piece 16 and cutting means 20, should be such that there is minimal opportunity for wobble or chatter of the food item 30 when the device is operated. Thus, the annular support 36 may be employed to maintain the relative position of the food item 30 stable.

As illustrated in FIGS. 1A-3, the cutting means 20 is driven directly by rotation of the end-piece 16, such that the interaction of the cutting means 20 to the food item 30 is both smooth and continuous, thereby resulting in the production of uniform shavings with little skill required by the operator. By permanently affixing one end of the threaded rod 40 with the end-piece 16, it is possible to synchronize the downward longitudinal movement of the follower 28 along the threaded rod 40 upon rotation of the end-piece 16. The synchronized timing between the movement of the follower 28 and the end-piece 16 controls the amount of food item 30 that encounters the beveled edge of the blade 20 positioned within the end-piece 16. In other words, it determines the thickness of the shaving. The end-piece 16 can include knurling (not shown) on the exterior surfaces thereof to aid in gripping by the end-user.

It is contemplated by the instant invention to provide shaver assemblies that produce shavings of varying thickness. This may be accomplished, e.g. by providing a shaver assembly having a rod 40 with a relatively coarse pitch and/or reducing the number of blades 20 acting on the food item 30. Additionally, it is contemplated to provide an assembly that creates different configurations of shavings (e.g. helical curls, spiral curls, ribbons, etc). This may be accomplished by varying the shape of the end-piece, e.g. the angles created between the cutting means 20 and the longitudinal axis of the food item 30.

In operation of the above mentioned embodiment illustrated in FIGS. 1A-3, the user removes a cap 22 from the pre-assembled device 10 containing the food item 30, grasps the container 12 in one hand and rotates end-piece 16 with the other hand, as shown in FIG. 3. Such action causes two things to happen. First, the blade 20 contained within the end-piece 16 rotates relative to the food item 30. Second, the food item 30 is moved at a predetermined rate towards end-piece 16 by interaction between follower 28 and threaded rod 40. These combined actions cause food item 30 to be forced into contact with the chamfered blade 20 at a precisely controlled, constant rate whereupon the chocolate or other suitable food is shaved by blade 20 and exits the assembly 10 through the opening 18 having the desired shape and thickness, as shown in FIG. 3. When sufficient shavings 45 have been produced the user can simply replace the cap 22 and store the assembly 10. Any remaining food product in the assembly 10 is kept uncontaminated and fresh for the next use.

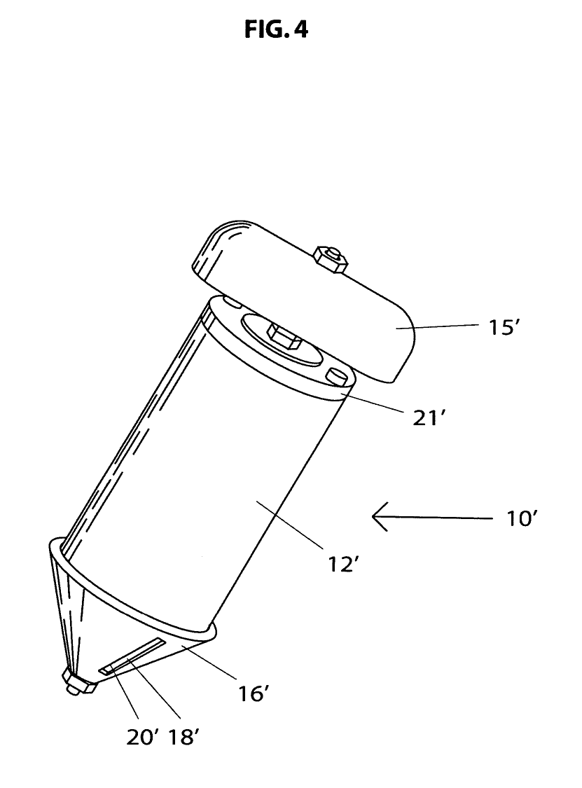

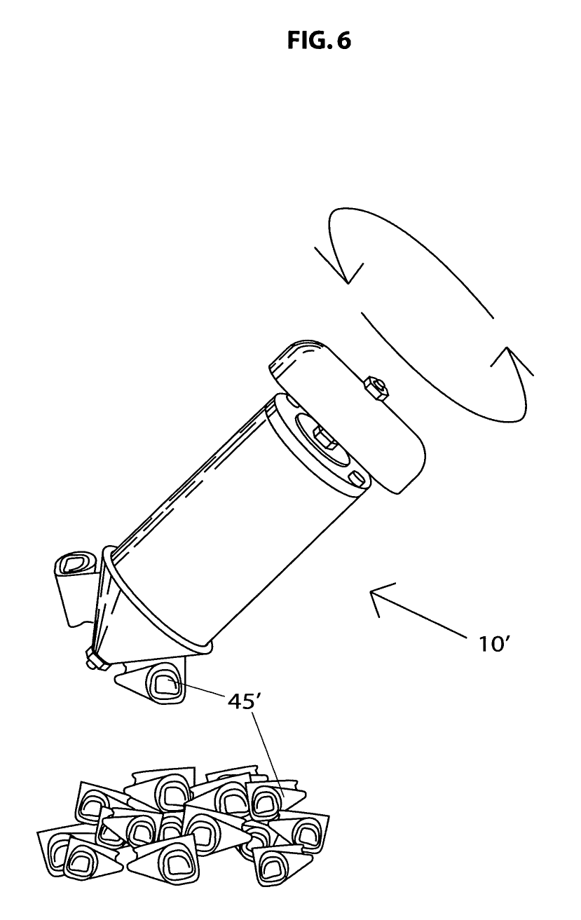

Referring now to FIGS. 4-6, wherein like elements are numbered consistently throughout, FIG. 4 illustrates an isometric view of an alternative shaver assembly or device, generally referenced as 10′. The shaver assembly 10′ comprises container 12′, an end-piece 16′ and knob 15′. The end-piece 16′ having at least one chamfered cutting means 20′, such as a blade, and at least one opening or window 18′ positioned adjacent to the cutting means 20′ for expulsion of the shavings 45′ from the device (FIG. 6.)

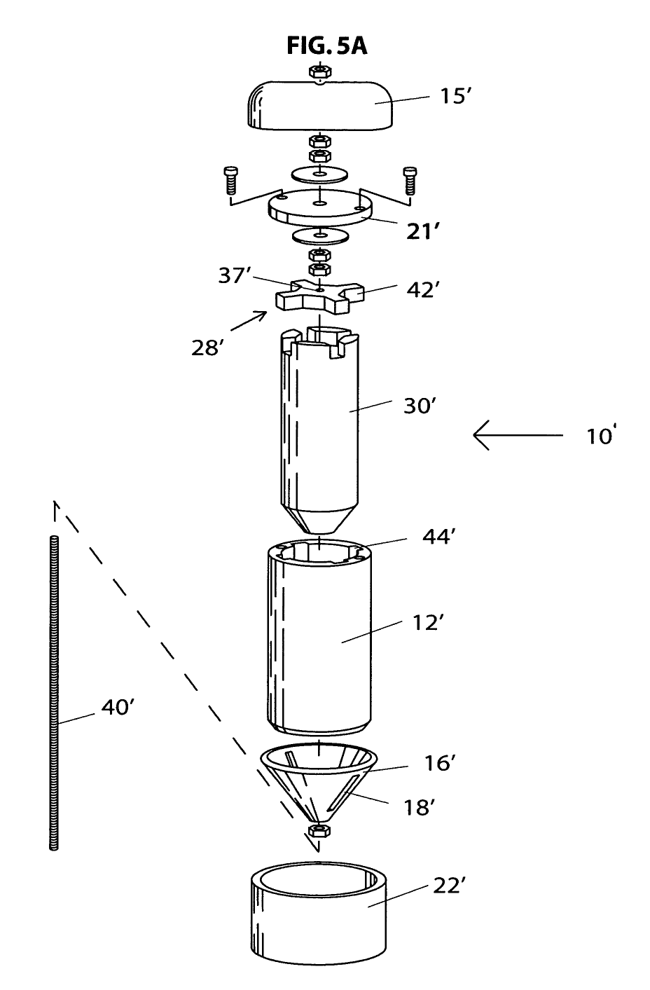

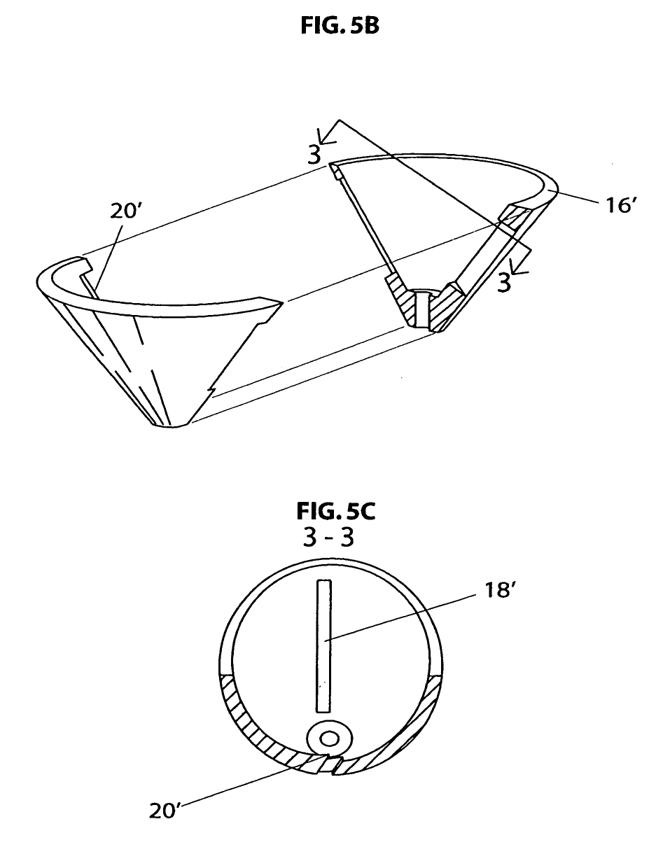

FIG. 5A illustrates an exploded view of the second embodiment of the present invention, wherein the container 12′ is rotatably connected to the end-piece 16′ on one end and non-rotatably connected to end-cap 21′ on the opposite end thereof by any means known in the art, for example, screws. The container 12′ includes a follower 28′ therein and a threaded rod 40′ located along the longitudinal axis of the container which mate with apertures formed in the end-cap 21′ and the knob 15′, such that the rod rotatably connects the knob 15′ to the endcap 21′. Additionally, the knob 15′ can include any ergonomic configuration known to those of ordinary skill to aid in rotation by the user, including finger indentations (not shown) or the like.

Like the aforementioned embodiment, the threaded rod 40′ transverses the follower 28′ through a corresponding threaded aperture 37′ and is non-rotatably attached to the end-piece 16′ to form the complete assembly 10′ (FIG. 4) which contains a pre-packaged food item 30′ therein. The rod 40′ can be connected to the knob 15′, end-cap 21′ and end-piece 16′ by any means known in the art, including nuts, pins, etc.

Referring now to FIG. 5B, which depicts the cross-sectional view of the end-piece 16′ and FIG. 5C which illustrates how the cutting means 20′ extends into the interior region of end-piece 16′ at a predetermined angle relative to the 3-3 axis shown in FIG. 5B.

As shown in FIG. 5A, the peripheral edge of the follower 28′ is generally of the same transverse shape as the container 12′ and the follower 28′ is prevented from rotating relative to container 12′ by a means to engage corresponding elements formed within the container 12′ sidewalls. For example, the means to engage can include at least one wing 42′ formed on the peripheral edge of the follower 28′ that slidingly engage at least one correspondingly sized groove 44′ formed within interior of the container 12′. Alternatively, the means to engage could contain wings (not shown) projecting from the interior of the container, which slidingly engage corresponding grooves (not shown) formed on the peripheral edge of the follower 28′.

In operation when rotational force or torque is applied to the knob 15′ by the user, the force is transferred down the rod 40′ to the end-piece 16′. The rotation of the rod 40′ causes the follower 28′ to translate relative to the longitudinal axis of the threaded rod 40′, but the engagement means does not allow the follower 28′ to rotate about longitudinal axis. The food item 30′ is moved at a predetermined rate toward the end-piece 16′ and into contact with the blade 20′ and the shaving 45′ produced by the blade 20′ is expelled through at least one window 18′, as shown in FIG. 6.

By permanently connecting one end of the threaded rod 40′ with the end-piece 16′, it is possible to synchronize the downward longitudinal movement of the follower 28′ along the threaded rod 40′ upon rotation of the knob 15′. This synchronized timing between the movement of the follower 28′ and the end-piece 16′ provides a predetermined amount of food item 30′ to encounter the beveled edge of the blade 20′ positioned in the end-piece 16′.

With any of the abovementioned embodiments, a plurality of blade/window combinations may be employed as desired. The use of additional blade/window combinations located radially along the end-piece 16, 16′ permits multiple shavings to be produced simultaneously (FIG. 6.) Additionally, this simultaneous shaving process results in a thinner shaving when compared to shavings of prior art systems using a single blade since the depth of the shaving action is a function of the number of the blades and the pitch of threaded rod 40, 40′. The frustoconical shape of end-piece 16, 16′ further serves to maintain concentricity of end-piece 16, 16′ relative to food item 30, 30′. Additionally, the frustoconical shape of end-piece 16, 16′ determines the angle of attack and angle of the blade 20, 20′ relative to the food item, thereby producing shavings that are more or less telescoped and more or less curled to enhance visual interest to the shavings.

Preferably, the food item 30, 30′ is pre-packaged by the manufacturer within the interior space created between end-piece 16, 16′ and a follower 28, 28′. The pre-packaged food item 30, 30′ is generally shaped similar the interior of the container 12, 12′ and has an interior bore running its entire length (e.g. preformed). As shown in FIGS. 2A and 5A, one end of food item 30, 30′ is shaped to closely match the shape of the interior end of end-piece 16, 16′ such that it may interact substantially with the entire length of blade 20, 20′.

In a preferred, albeit non-limiting embodiment, the follower 28, 28′ is a polygonal shape and the end of the food item 30, 30′ in contact with the follower 28, 28′ is shaped to mate with the follower 28, 28′ such that the force acting transferred to the food item 30, 30′ by the follower 28, 28′ may be effectively distributed so as to prevent damage to the food item 30, 30′. The general shape of follower 28, 28′ should be such that it substantially corresponds with the frustoconical shape of end-piece 16, 16′ in order for essentially all of the food item 30, 30′ to be utilized with minimal waste. Furthermore, the follower 28, 28′ can include teeth (not shown), as disclosed in U.S. Pat. No. 5,071,663 to Dugan (previously incorporated by reference), that can penetrate the top of the food item 30, 30′ to effectively grip the food item 30, 30′ such that the food item 30, 30′ does not wobble or chatter as it is being shaved. If the food item is permitted to wobble significantly during the shaving action, the form of the shavings or curls may suffer.

In another preferred embodiment, the peripheral edge of said follower 28, 28′ can be provided in substantially fluid-tight contact with the sidewall of the container 12, 12′ to preclude passage of said food item 30, 30′ past the peripheral edge of said follower as the follower advances along the longitudinal axis of said container. The peripheral edge of the follower 28, 28′ can include a disc seal (not shown) as disclosed in U.S. Pat. No. 4,714,205 to Steinko (previously incorporated by reference) or a resilient O-ring (not shown) housed within a notch on the periphery of the follower 28, 28′, as disclosed in U.S. Pat. No. 4,127,375 to Nelson (formerly incorporated by reference).

Additionally, a cap 22, 22′ (shown in FIGS. 1A, 5A, respectively) can be included which fits securely over the end-piece 16, 16′ when the device is to be stored or otherwise not in use. Preferably, the cap 22, 22′ is constructed such that it substantially covers the end-piece 16, 16′. In a preferred embodiment, the cap 22, 22′ can include an o-ring or gasket (not shown) to provide an air-tight seal such that the food item within the container 12, 12′ remains fresh when not in use. Other suitable engagement means can include those known in the art, such as screw threads, bayonet fittings, snap fittings or other attachment means known in the art. Additionally, the cap 22, 22′ can include a pedestal base portion (not shown), such that the device can be free standing such as is found in U.S. Pat. No. 5,261,613 (herein incorporated by reference in its entirety.)

All of the components of the assemblies 10, 10′ may be made from plastic resin, metal or any other suitable material. The cutter blades may be fabricated of a suitable plastic and may be part of end-piece 16, 16′ or the blades may be made of metal, ceramic or other suitable material and attached to end-piece 16, 16′ by any means known in the art (e.g. adhesive, welding, etc). For example, the device may be fabricated out of clear plastic or by incorporating windows such that the amount of the food portion remaining is visible to the user. Additionally, other means known in the art may be provided to inform the user of the remaining portion.

The length, diameter or other dimensions of the pre-packaged food item may be varied as desired. The geometry of the food item may be irregular so as to produce irregular shavings. Likewise, modifying the shape of the blade 20, 20′, for example, saw-shape, sinuous, etc, can produce irregular shavings or curls. Moreover, the assembly 10, 10′ can be pre-packed with two or more varieties of food into a single food item, for example, white chocolate and dark chocolate, so that striped or checkered shavings can be produced by the device of the instant invention.

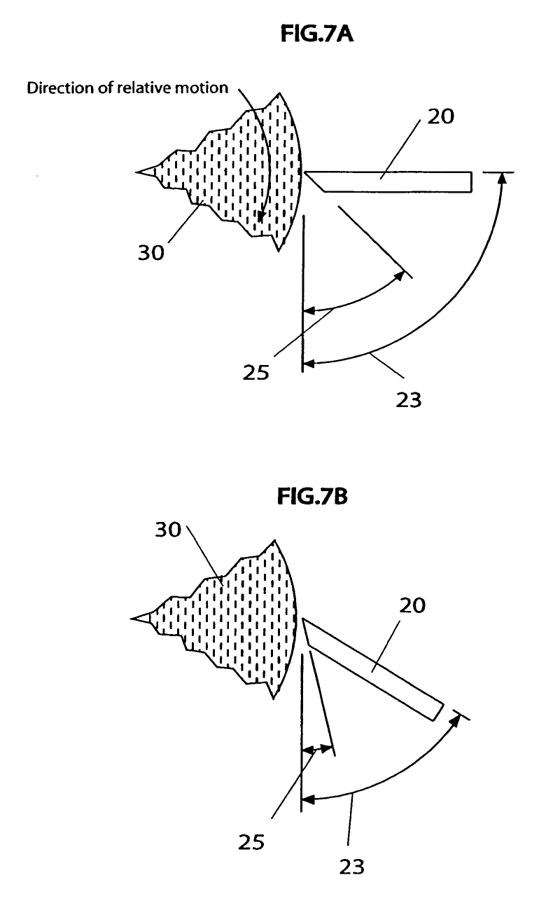

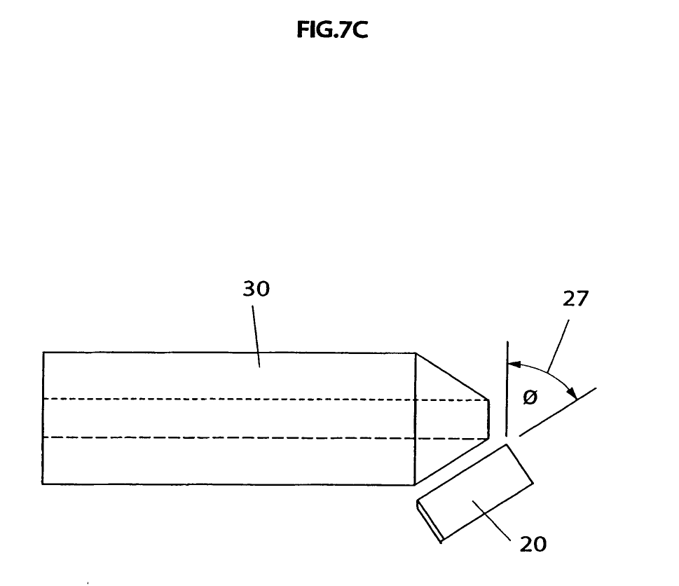

It was discovered by the present inventors that the end-piece 16, 16′ could be formed such that the angle 23 (e.g. angle of attack) created between the chamfered tip of the blade 20, 20′ and the tangent formed from the food item 30, 30′, as seen along the plane transverse to the longitudinal axis of the food item 30, 30′, dictate the degree or “tightness” of curl produced, as seen in FIGS. 7A and 7B. The blade relief angle 25 shown therein refers to the angle of the chamfered tip of the blade 20, 20′ fabricated by the blade's 20, 20′ manufacturer. Thus, if the angle of attack 23 is about 90 degrees (e.g. normal) to the tangent then essentially flat ribbons are produced. When the blade 20, 20′ is rotated about the longitudinal axis of the food item 30, 30′ such that the angle of attack 23 is at about 45 degrees to the tangent, compact curls are produced (FIG. 7B). Therefore, the angle of attack 23 of the chamfered blade 20, 20′ should be provided between about 90 degrees and the predetermined relief angle 25, such that only the chamfered tip of the blade 20, 20′ contacts the food item 30.

Additionally, as illustrated in FIG. 7C, the end-piece 16, 16′ could be formed such that the angle=ø, 27, created between the chamfered cutting edge of the blade 20 and transverse axis of the food item 30, 30′ dictates the degree of spiral, or telescoping, of the shavings produced. For example, in order for the device to engender flat, rectangular ribbons the angle=ø, 27, should be about 0 degrees. On the other hand, if long helical, spiral and telescopic type curls are desired, the angle of the blade 20 relative to the transverse axis should be closer to 90 degrees. Thus, these two angles (e.g. angle of attack and ø) work in concert to dictate the degree of curl and amount of telescoping desired, and hence the amount of visual interest produced by the device.

Moreover, it has been realized by the present inventors that certain food products with a certain shaving thickness appear more pleasing and offer a better mouth-feel than others. For example, shavings in the range of approximately 0.001 inches to 0.03 inches thick have a very good mouthfeel in that they melt instantly in the mouth. However, shavings thinner than 0.001 inches, while having good mouth-feel, are generally incapable of supporting their own three-dimensional shape.

The thickness of the shavings produced by the instant invention can be varied by controlling the relative rate of feed of the food item into the rotating blade(s) 20, 20′ with respect to the number of blade revolutions. For example, if the feed rate of the food item 30, 30′ is increased per revolution of the blade(s), then thicker shavings will result. Similarly, if the number of blades are increased, with no change in feed rate per revolution of the end-piece 16, 16′, then the shavings produced will be thinner than those produced by fewer blades.

Furthermore, thicker shavings can be created using a relatively coarse pitch (i.e. number threads per inch) for the threaded rod 40, 40′ and/or reducing the number of blades 20, 20′ acting on the food item 30, 30′. It has been found that using a softer food item such as “tropical” chocolate, or food at an elevated temperature, shavings may be effectively produced which are 0.030 inches thick or even thicker, the preferred thickness for shavings is between about 0.003 inches and about 0.030 inches thick. Thus depending on the food item to be shaved, the assembly 10, 10′ can be pre-packaged with a rod/blade configuration that will generate thick or thin shavings depending on the desire of the consumer. In one preferred embodiment the threaded rod 40, 40′ comprises a stainless steel rod of No. 4 diameter with 40 threads per inch and two cutter blades 20, 20′ were employed. This configuration yields shavings with a thickness of approximately 0.0125 inches.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification.

One skilled in the art will readily appreciate that the present invention is well adapted to carry out the objectives and obtain the ends and advantages mentioned, as well as those inherent therein. The various apparatus, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

1. A kit for storage and slicing of food items into decorative shavings comprising:
at least one disposable, hand-held shaver assembly structured and arranged for the storage and slicing of at least one food item pre-packaged therein, said assembly including a container defined by a first end, a second end, and at least one sidewall, wherein said first end and said second end are in spaced apart relation along a longitudinal axis thereof;
a follower adapted for placement within said container and including a threaded aperture in operable connection to a drive means for advancement of said at least one food item along said longitudinal axis of said container toward an end-piece, said end-piece operably connected to said second end of said container, said follower including a means to engage said container in a manner which precludes rotation of said follower about the longitudinal axis;
said drive means including a threaded rod adapted for insertion through said follower aperture to provide synchronized movement of said follower along said longitudinal axis while providing rotational movement to said end-piece;
said end-piece being operably connected to said threaded rod, said end-piece including at least one integrally attached cutting means constructed and arranged for producing shavings of said at least one food item and at least one opening adjacent said cutting means for expulsion of said shavings;
wherein said at least one preformed food item is positioned within an interior space defined by said follower and said end-piece.

2. The kit as set forth in claim 1, wherein said drive means further comprises a knob assembly attached to an end of said threaded rod opposite said end-piece;
wherein rotation of said knob assembly transfers torque along said threaded rod to said end-piece while causing said follower to translate relative to the longitudinal axis.

3. The kit as set forth in claim 1, wherein said end-piece and said second end are operatively engaged in a manner effective to inhibit counter-rotation.

4. The kit as set forth in claim 1, wherein the peripheral edge of said follower is in substantially fluid-tight contact with said at least one sidewall to preclude passage of said food item past the peripheral edge of said follower as the follower advances along the longitudinal axis of said container.

5. The kit as set forth in claim 1, wherein said end-piece comprises a frustoconical shape and said cutting means comprises a plurality of cutting elements and adjacent openings arranged in predetermined concentric locations in said end-piece.

6. The kit as set forth in claim 5, wherein said follower is of substantially the same frustoconical shape as said end-piece, wherein substantially all of said food item is pushed through said end-piece when said follower is advanced into said end-piece.

7. The kit as set forth in claim 1, wherein said end-piece produces shavings of about 0.003 inches to about 0.03 inches thick.

8. The kit as set forth in claim 1, further comprising a cap that fits securely over said end-piece when the assembly is not in use.

9. A disposable, hand-held device for storage and slicing of at least one food item into decorative shavings comprising:
a container defined by a first end, a second end, and at least one sidewall, wherein said first end and said second end are in spaced apart relation along a longitudinal axis thereof;
a follower adapted for placement within said container and including a threaded aperture in operable connection to a drive means for advancement of said at least one food item along said longitudinal axis of said container toward an end-piece, said end-piece operably connected to said second end of said container, said follower including a means to engage said container in a manner which precludes rotation of said follower about the longitudinal axis;
said drive means including a threaded rod adapted for insertion through said follower aperture to provide synchronized movement of said follower along said longitudinal axis while providing rotational movement to said end-piece;
said end-piece being operably connected to said threaded rod, said end-piece including at least one integrally attached cutting means constructed and arranged for producing shavings of said at least one food item and at least one opening adjacent said cutting means for expulsion of said shavings;
wherein said device is adapted to contain at least one preformed food item therein.

10. The device as set forth in claim 9, wherein said drive means further comprises a knob assembly attached to an end of said threaded rod opposite said end-piece;
wherein rotation of said knob assembly transfers torque along said threaded rod to said end-piece while causing said follower to translate relative to the longitudinal axis.

11. The device as set forth in claim 9, wherein said end-piece and said second end are operatively engaged in a manner effective to inhibit counter-rotation.

12. The device as set forth in claim 9, wherein the peripheral edge of said follower is in substantially fluid-tight contact with said at least one sidewall to preclude passage of said food item past the peripheral edge of said follower as the follower advances along the longitudinal axis of said container.

13. The device as set forth in claim 9, wherein said end-piece comprises a frustoconical shape and said cutting means comprises a plurality of cutting elements and adjacent openings arranged in predetermined concentric locations in said end-piece.

14. The device as set forth in claim 13, wherein said follower is of substantially the same frustoconical shape as said end-piece, wherein substantially all of said food item will pushed through said end-piece when said follower is advanced into said end-piece.

15. The device as set forth in claim 9, wherein said end-piece produces shavings of about 0.003 inches to about 0.03 inches thick.

16. The device as set forth in claim 9, further comprising a cap that fits securely over said end-piece when the device is not in use.

17. The device as set forth in claim 9, wherein said food item comprises at least one food item selected from the group consisting of chocolate, nougat, caramel, butter, toffee, meat, cheese, dough, nuts, fruit, vegetable, marzipan, pet food and combinations thereof.
